(19) United States
(12) Patent Application Publication
(10) Pub. No.: US 2021/0182614 A1
(43) Pub. Date: Jun. 17, 2021

(54) SEARCH METHOD AND NON-TRANSITORY COMPUTER-READABLE STORAGE MEDIUM

(71) Applicant: SEIKO EPSON CORPORATION, Tokyo (JP)

(72) Inventors: Shinji MAGARA, Matsumoto-shi (JP); Mitsunori KAJIMA, Suwa-shi (JP)

(21) Appl. No.: 17/117,360

(22) Filed: Dec. 10, 2020

(30) Foreign Application Priority Data
Dec. 11, 2019 (JP) 2019-223548

(51) Int. Cl. G06K 9/62; G06N 20/00

(52) U.S. Cl. CPC G06K 9/6257; G06N 20/00; G06K 9/6232

(57) ABSTRACT

A search method includes: (a) training a first model such that a resulting object with which a first state is associated can be correctly identified from at least one first factor data element; (b) determining whether the resulting object with which the first state is associated is correctly identified at a predetermined ratio or more; (c) training a second model such that the resulting object with which the first state is associated can be correctly identified from at least one second factor data element when it is determined that the resulting object cannot be correctly identified at the ratio or more; and (d) by using the first model trained by the training (a) and the second model trained by the training (c) according to a determination result of the determining (b), extracting at least one factor combination that identifies the resulting object with which the first state is associated at a highest ratio.

The present application is based on, and claims priority from JP Application Serial Number 2019-223548, filed Dec. 11, 2019, the disclosure of which is hereby incorporated by reference herein in its entirety.

### BACKGROUND

### 1. Technical Field

The present disclosure relates to a technique for searching for a factor related to a specific state with respect to a resulting object.

### 2. Related Art

In order to improve a yield in a manufacturing process or a processing process, it is desired to find out a factor that is reducing the yield based on a history related to a device used in the manufacturing process or the processing process, various measurement data, or the like. For this purpose, it is more efficient to find the factor by performing data analysis based on a data element such as the history related to the device collected in advance or various measurement data, rather than actually perform physical analysis and experimental verification.

In the related art, as a technique for finding a factor that reduces the yield, there is known a technique of selecting actual measurement data to be used as analysis data from actual measurement data by using a correlation-based feature selection (CFS) method and building a probability inference model using the selected actual measurement data. (JP-A-2018-163622). In the technique in JP-A-2018-163622, a factor is found using the built probability inference model. Further, in the related art, there is known a technique for finding a factor by a method using regression tree analysis (JP-A-2001-306999).

In a technique in the related art, when a large number of factors that reduce the yield are extracted, it is difficult to control all the factors in the manufacturing process or the processing process. Therefore, it may be necessary to narrow down the factors in advance from a large number of extracted factor candidates by physical analysis or an experimental verification. However, with the technique in the related art, it is difficult to acquire useful information for narrowing down the factors, and it may not be possible to efficiently narrow down the factors. In particular, when a plurality of factors that reduce the yield constitute a plurality of classified combinations, it is difficult to efficiently extract the factors constituting each combination. Such a problem is common not only to a technique for finding a factor that reduces the yield but also for a technique for finding a factor associated with a specific state of a resulting object manufactured or processed by a manufacturing process or a processing process.

### SUMMARY

According to one aspect of the present disclosure, there is provided a search method in which at least one or more processors search for a factor associated with a first state using a data set including (i) a plurality of factor data elements which are linked to each of a plurality of resulting objects manufactured or processed by a manufacturing process or a processing process and which represent a plurality of factors and (ii) a label which is used for representing one of the first state and a second state and which is associated with the resulting object. The search method includes: (a) by using (i) at least one first factor data element belonging to a first combination as a factor combination among the plurality of factor data elements and (ii) the label corresponding to the first factor data element, training a first model such that the resulting object with which the first state is associated can be correctly identified from the at least one first factor data element; (b) determining whether the trained first model correctly identifies the resulting object with which the first state is associated at a predetermined ratio or more by using the first factor data element belonging to the first combination; (c) when it is determined that the resulting object cannot be correctly identified at the ratio or more in the determining (b), by using (i) at least one second factor data element which belongs to a second combination as the factor combination among the plurality of factor data elements and is different from the first factor data element and (ii) the label corresponding to the second factor data element, training a second model such that the resulting object with which the first state is associated can be correctly identified from the at least one second factor data element; and (d) by using the first model trained by the training (a) and the second model trained by the training (c) according to a determination result of the determining (b), extracting at least one factor combination that identifies the resulting object with which the first state is associated at a highest ratio.

### BRIEF DESCRIPTION OF THE DRAWINGS

FIG. 1 is a diagram for explaining an analysis system according to the present disclosure.

FIG. 2 is a flowchart for explaining an outline of a factor search process executed by an analysis device.

FIG. 3 is a first diagram for explaining an outline of the factor search process.

FIG. 4 is a second diagram for explaining the outline of the factor search process.

FIG. 5 is a flowchart of the factor search process executed by a processor of the present embodiment.

FIG. 6 is a first diagram for explaining the factor search process.

FIG. 7 is a second diagram for explaining the factor search process.

FIG. 8 is a third diagram for explaining the factor search process.

FIG. 9 is a fourth diagram for explaining the factor search process.

FIG. 10 is a flowchart of the factor search process executed by a processor of the second embodiment.

FIG. 11 is a first diagram for explaining the factor search process.

FIG. 12 is a second diagram for explaining the factor search process.

FIG. 13 is a third diagram for explaining the factor search process.

FIG. 14 is a fourth diagram for explaining the factor search process.

### DESCRIPTION OF EXEMPLARY EMBODIMENTS

### A. First Embodiment

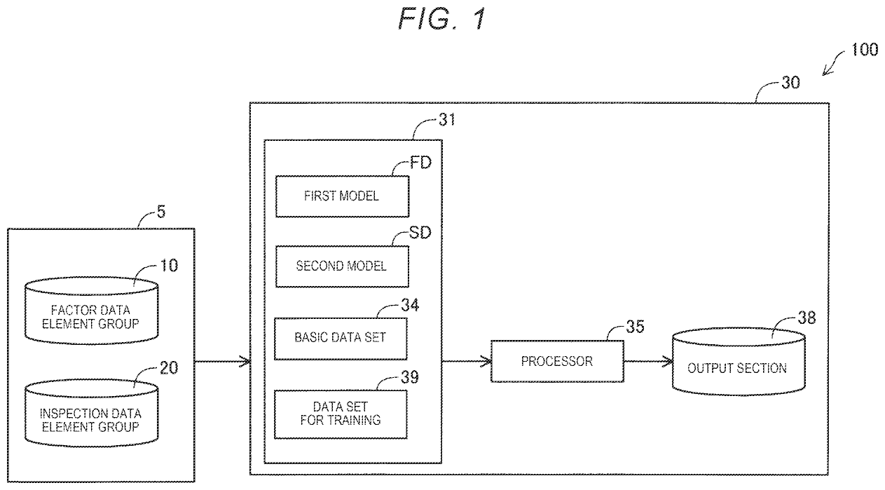

FIG. 1 is a diagram for explaining an analysis system 100 according to the present disclosure. The analysis system 100 is a system for searching for a factor that causes a defective product in a manufacturing process for manufacturing a resulting object 200 such as an industrial product or a processing process for processing a target object to obtain a resulting object 200. In the present embodiment, an analysis system 100 used in a manufacturing process for manufacturing a circuit substrate will be described as an example. Further, in the present embodiment, the circuit substrate, which is the resulting object 200, is inspected as to whether the circuit substrate is in a first state indicating a defective product that cannot be shipped, or in a second state indicating a good product that can be shipped.

The analysis system 100 includes collected data 5 and an analysis device 30. The collected data 5 has a factor data element group 10 and an inspection data element group 20. The collected data 5 is stored in a storage device. The storage device may be a storage device included in the analysis device 30, or a device different from the analysis device 30, for example, an external storage device such as an HDD.

The factor data element group 10 is constituted by a plurality of factor data elements xi which can be obtained by assuming as factors that cause the resulting object 200 to be in the first state or the second state in the manufacturing process or the processing process. The factor data element group 10 has a history related to a manufacturing device for manufacturing the circuit substrate that is the resulting object 200 or each of various measurement data as a factor data element xi. Examples of the history include an identifier for identifying the manufacturing device, the number of years elapsed from the initial state, or an operation history related to an operation such as continuous operation time or stop time. Further, various measurement data include, for example, a processing condition such as processing temperature or processing time in each manufacturing step, or actual size data of the resulting object 200 such as a processed object. The types of the factor data elements xi constituting the factor data element group 10 are, for example, 500 types or more, or 1000 types or more.

The inspection data element group 20 is constituted by an inspection result of the circuit substrate which is the resulting object 200. As the inspection result, a label used to indicate one of the first state indicating a defective product and the second state representing a good product can be mentioned. This label is associated with each of the plurality of resulting objects 200 according to the inspection result of the inspection device or the inspection result by an inspector. Further, when a model generated by machine learning described later is trained by using the regression analysis as an algorithm, the inspection result includes, as a label, an index value for determining whether the resulting object belongs to the first state or the second state, for example, an actual measurement value such as strength. For example, it is determined that the resulting object 200 belongs to one of the first state and the second state depending on whether the actual measurement value is equal to or greater than a predetermined threshold value. That is, the label may be a label indicating two states, the first state indicating a defective product and a second state representing a good product, or may indicate an actual measurement value obtained by measuring the physical amount of the resulting objects 200.

The analysis device 30 uses a basic data set 34 generated using the collected data 5 to extract at least one factor combination that identifies the resulting object 200 with which the first state is associated at the highest ratio. The analysis device 30 is, for example, an electronic calculating machine such as a personal computer. The analysis device 30 includes a storage section 31, a processor 35, and an output section 38.

The storage section 31 is constituted by a ROM, a RAM, an HDD, or the like. The storage section 31 stores various programs executed by the processor 35 and the basic data set 34. The basic data set 34 is data in which the factor data element group 10 and the inspection data element group 20 are associated with each other. In the basic data set 34, for example, with respect to the resulting object 200, the factor data elements xi such as various devices or various processing conditions used in the manufacturing process and labels indicating the inspection results are associated with each other. As described above, the basic data set 34 includes a plurality of factor data elements which are linked to each of the plurality of resulting objects 200 and labels used to represent one of the first state and the second state and associated with the resulting objects. Further, the storage section 31 stores a first model FD as a model generated by the processor 35 and a second model SD as another model.

The processor 35 has functions of executing the training of the first model FD or the second model SD using the basic data set 34 and transmitting the analysis result using the first model FD or the second model SD with respect to the output section 38. In the present embodiment, the processor 35 extracts a plurality of important factor data elements xj that have a high degree of influence on the first state from among the plurality of factor data elements xi included in the basic data set 34. The processor 35 generates a data set for training 39 that includes the content of the important factor data element xj in accordance with the resulting object 200 and the label, from the basic data set 34. The first model FD or the second model SD is trained using the data set for training 39 as this data set. The processor 35 may realize various functions by executing various programs stored in the storage section 31, or may realize various functions by a hardware circuit. Details of various functions executed by the processor 35 will be described later.

The output section 38 displays the analysis result to a user. The output section 38 is, for example, a display device such as a liquid crystal panel.

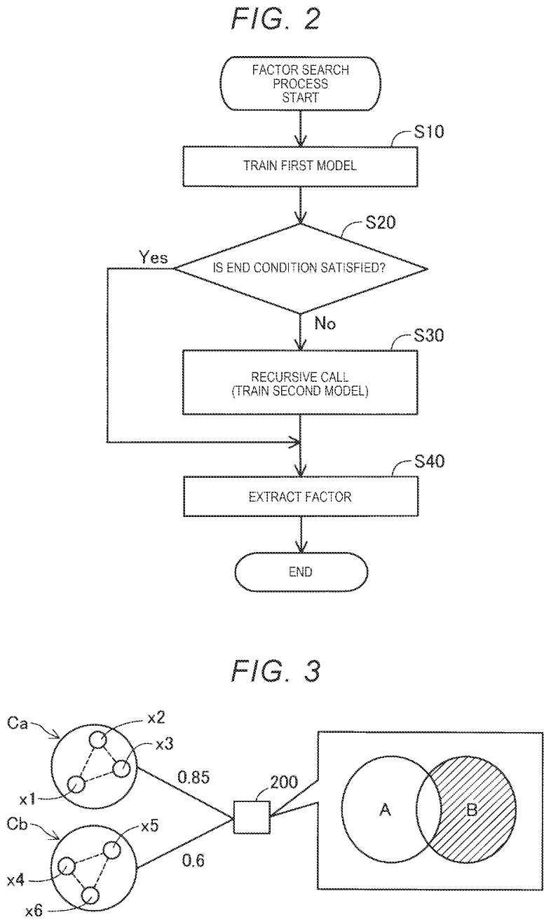

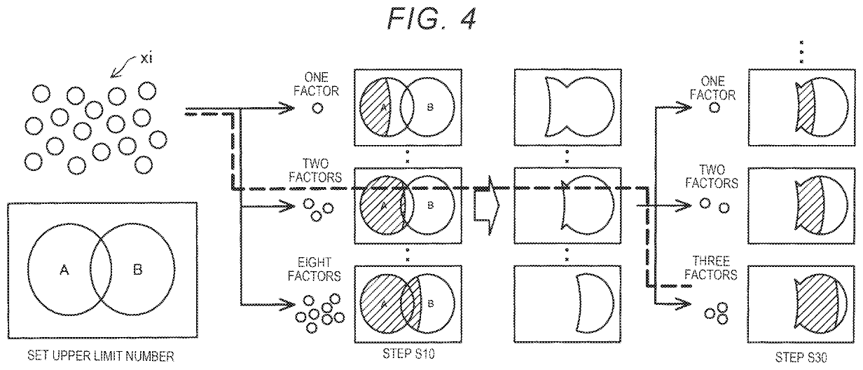

FIG. 2 is a flowchart for explaining an outline of the factor search process executed by the analysis device 30. FIG. 3 is a first diagram for explaining the outline of the factor search process. FIG. 4 is a second diagram for explaining the outline of the factor search process. In a search process, the processor 35 searches for a factor data element xi associated with the first state indicating a defective product from among the plurality of factor data elements xi.

As illustrated in FIG. 3, it is conceivable that two defective modes A and B are included as factors that are determined to be a defective product for the resulting object 200 which is determined to be a defective product. That is, it is determined to be a defective product when it has at least one of the defective mode A and the defective mode B for the resulting object 200. The defective mode A is, for example, a mode in which the resulting object 200 is determined to be a defective product due to insufficient strength. Further, the defective mode B is, for example, a mode in which the resulting object 200 is determined to be a defective product because the resulting object 200 is contaminated. The defective mode A can be explained by three factor data elements x1 to x3 which belong to a first combination Ca. That is, by using the three factor data elements x1 to x3 which belong to the first combination Ca, it is possible to identify whether the resulting object 200 is a defective product or not due to the defective mode A. On the other hand, the defective mode B can be explained by three factor data elements x4 to x6 which belong to a second combination Cb. That is, by using the three factor data elements x4 to x6 which belong to the second combination Cb, it is possible to identify whether the resulting object 200 is a defective product or not due to the defective mode B. In the present embodiment, it is assumed that defective products can be identified at the highest ratio by the three factor data elements x1 to x3 which belong to the first combination Ca and the three factor data elements x4 to x6 which belong to the second combination Cb. In the example illustrated in FIG. 3, the coefficient of determination representing the identification accuracy when the regression analysis is used in the search process is “0.85” for the defective mode A and “0.6” for the defective mode B.

An outline of a factor search process for searching for and extracting a factor combination when the first combination Ca and the second combination Cb as the factor combinations are in an unknown state, that is, when the combination that can identify a defective product at the highest ratio is unknown, will be described with reference to FIG. 4.

First, an upper limit number of the factor data elements xi which belong to each factor combinations is determined. In the example illustrated in FIG. 4, the upper limit number is “8” which is the upper limit number of the experimental verification level using an L18 orthogonal table, but the upper limit number may be determined by an input from a user.

After the upper limit number is determined, as illustrated in FIG. 2, in step S10, the processor 35 trains the first model FD so as to correctly identify the resulting object 200 with which the first state indicating a defective product is associated. Specifically, the processor 35 executes machine learning of the first model FD using various algorithms such as support vector machine (SVM), random forest, deep learning, and support vector regression (SVR).

In step S10, by referring to the data set for training 39, using at least one first factor data element xi belonging to the first combination Ca as a factor combination among the plurality of factor data elements xi and labels used to represent one of the first state indicating a defective product and the second state indicating a good product, the processor 35 trains the first model FD so as to correctly identify the resulting object 200 with which the first state is associated from the at least one first factor data element xi. That is, as illustrated in FIG. 4, when the number of factor data elements En that belong to the first combination Ca is each value from “1” to “8”, a combination of the factor data elements xi that can identify the resulting object 200 that is a defective product at the highest ratio is extracted from the plurality of factor data elements xi that constitute the data set for training 39. In the example illustrated in FIG. 4, the resulting object 200 that is a defective product can be identified in an area with single hatching.

As illustrated in FIG. 2, in step S20, the processor 35 determines whether the trained first model FD satisfies the end condition. Specifically, the processor 35 determines whether the first model FD can correctly identify the resulting object 200 with which the first state indicating a defective product is associated at a predetermined ratio or more using the first factor data element xi which belongs to the first combination Ca. For example, the ratio is set to a value of 95% or more. The data element for verification used for this determination is included in the data set for training 39. That is, the data set for training 39 includes a data element used for building the model and a data element for verifying the built model. The data element for verification is a data element similar to the factor data element xi included in the factor data element group 10 and is associated with a label used when the resulting object 200 represents one of the first state and the second state. Further, in step S20, a determination may be made whether to correctly identify the resulting object 200 using an area under curve (AUC), root mean squared error (RMSE), and coefficient of determination according to an algorithm, for example, regression analysis or discriminant analysis, which are used for training of the first model FD. Moreover, as an algorithm for extracting combinations of the factor data elements xi, for example, a wrapper, a filter, or an embedding may be used.

When it is determined that the end condition is satisfied, the processor 35 extracts a factor combination used when the first model FD that satisfies the end condition is trained from the plurality of first models FD generated for each number of factor data elements En. For example, when the number of factor data elements En is “8”, and the factor data elements which belong to the first combination Ca are “x1”, “x2”, “x3”, “x4”, “x5”, “x9”, “x11”, and “X20”, and when the end condition is satisfied, the following is extracted. That is, the processor 35 extracts the first combination Ca in which the factor data elements xi are “x1”, “x2”, “x3”, “x4”, “x5”, “x9”, “x11”, and “x20”. The extracted first combination Ca is output by the output section 38.

On the other hand, when the processor 35 determines that the end condition is not satisfied, a recursive call of steps S10 to S20 is executed in step S30. For the training of the second model SD executed by the recursive call, the remaining factor data elements xi are used, after excluding the factor data elements xi used for training of the previously trained model, for example, the first model FD. That is, when it is determined that the resulting object 200 with which the first state is associated cannot be correctly identified at a predetermined ratio or more by the first model FD, the processor 35 trains the second model SD using the second factor data elements which belong to the second combination Cb different from the first factor data elements xi, and the labels corresponding to the second factor data elements. That is, using the second factor data elements and the labels, the second model SD is trained so that the resulting object 200 with which the first state is associated can be correctly identified from at least one second factor data element. The second model SD is a model which is trained by the recursive call, and when a plurality of recursive calls are executed, a plurality of the second models SD are generated. That is, in step S30, steps S10 and S20 are executed for the second model SD.

As illustrated in FIG. 2, when the end condition is satisfied, the processor 35 extracts at least one factor combination that has the highest ratio capable of identifying the first state as a total, in step S40. That is, the processor 35 extracts at least one factor combination that identifies the resulting object 200 with which the first state is associated at the highest ratio by using the trained first model FD and the trained second model SD as desired. The factor combination is a combination including at least one or more factor data elements xi and may be, for example, the first combination Ca, the first combination Ca and the second combination Cb, or more combinations. In the example illustrated in FIG. 4, the first model FD is generated and the second model SD is generated by one recursive call, and a path indicated by the dotted line, that is, the first factor combination having three types of first factor data elements and the second factor combination having three types of second factor data elements are extracted.

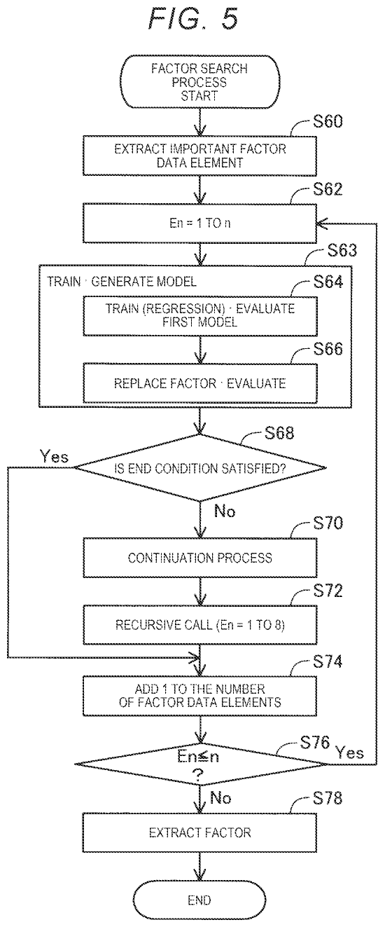

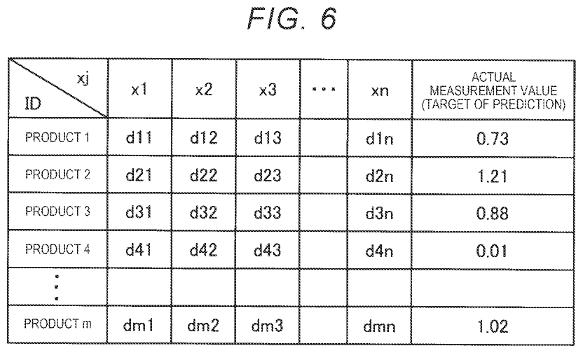

FIG. 5 is a flowchart of a factor search process executed by the processor 35 of the present embodiment. FIGS. 6 to 9 are diagrams for explaining the factor search process. As illustrated in FIG. 5, in step S60, the processor 35 is linked to a plurality of the resulting objects 200 and extracts the state of the resulting object 200, specifically extracts a plurality of important factor data elements xj that have a high degree of influence on the first state from among the plurality of factor data elements xi that can affect the first state, which is a defective product. The plurality of factor data elements xi are stored in the basic data set 34 illustrated in FIG. 1. The processor 35 extracts 100 important factor data elements xj using gradient boosting decision tree (GBDT), for example. When distinguishing 100 important factor data elements xj in terms of expression, reference numerals x1 to x100 are used. Further, in step S60, the level of the degree of influence on the first state is also calculated, and the reference numerals x1 to x100 are assigned in the order of the important factor data elements xj having a high degree. That is, the important factor data element x1 has the highest degree of influence. The extracted important factor data elements xj and the labels related thereto are stored in the storage section 31 as a data set for training 39. The processor 35 executes the subsequent process by using the plurality of important factor data elements xj which are extracted in step S60. By doing so, the amount of data used when the first model FD or the second model SD is trained can be reduced so that the processing time of the factor search process can be shortened.

Next, in step S62, the processor 35 determines the number of factor data elements En to be searched. The number of factor data elements En is the number of factor data elements xi constituting a factor combination used for training of a model for identifying the resulting object 200 with which the first state is associated. For example, the processor 35 determines the number of factor data elements xi in order from 1 to the upper limit number n. That is, in a first routine, the number of factor data elements xi constituting the factor combination is determined to be “1”.

Next, in step S63, a model is generated with training by the processor 35. The model which is trained before the recursive call described below is the first model FD. First, in step S64, using the factor data element xi belonging to the first combination and the label of the resulting object 200 corresponding to the factor data element xi as an input element, the processor 35 trains the first model FD so that the resulting object 200 with which the first state is associated can be identified, that is, a result that can identify a defective product can be output.

In the present embodiment, the processor 35 trains the first model FD by using the regression analysis such as SVR or random forest. In this case, a label of the input element is a data element serving as an index for determining whether the resulting object 200 belongs to the first state or the second state. Specifically, the label of the input element is an actual measurement value obtained by measuring a physical amount such as strength or thickness of the resulting object 200. When the first model FD is trained using the first combination, the label is an actual measurement value obtained by measuring the physical amount of the resulting object 200 which is used for determining whether the resulting object is in the first state or the second state. Further, when the second model SD is trained by the recursive call described later, the following is used for the label. That is, when the first model FD is trained by the first combination, the label is a residual difference between the actual measurement value and the predicted value using the first model FD. Further, when the second model SD is repeatedly trained by the recursive call, the label is a residual difference between the residual difference that is the input element when the second model SD is trained one step before and the predicted value that uses the second model SD one step before.

Further, in step S64, the processor 35 evaluates the identification performance of the first model FD. Specifically, the processor 35 uses the data element for verification as an input element of the first model FD and evaluates the identification performance by using the coefficient of determination. Accordingly, a first model FD having the highest identification performance in the number of factor data elements En determined in step S62 is determined. The first model FD having the highest identification performance for each number of factor data elements En is referred to as first models FD1 to FD8. The number at the end is a number corresponding to the number of factor data elements En.

In step S64, the processor 35 determines the important factor data elements xj of the first combination which is assumed to have the highest degree of influence on the first state. The processor 35 trains the first model FD using the determined important factor data element xj as a first factor data element and the label corresponding to the important factor data element xj as input elements. The levels of the degree of influence on the first state for the plurality of important factor data elements xj are calculated by the process of step S60. For example, when the number of factor data elements En is “1”, the process of step S64 is executed by using the important factor data element x1 that has the highest degree of influence on the first state calculated in step S60. Further, for example, when the number of factor data elements En is “2”, the process of step S64 is executed by using the top two important factor data elements x1 and x2 that have a high degree of influence on the first state calculated in step S60.

Next, in step S66, the processor 35 trains the first model FD by replacing the important factor data elements xj of the first combination used for training of the first model FD while maintaining the number of factor data elements En and determines the first model FD having the highest identification performance by comparing the identification performance of all the trained first models FD. For example, the first model FD is generated by training the first model FD by replacing the important factor data elements xj in the descending order of influence extracted in step S60. In step S66, the processor 35 evaluates the identification performance of the first model FD generated by replacing the important factor data elements xj. When the identification performance of the first model FD generated by the replacement is lower than the identification performance of the first model FD before the replacement generated in step S64, the first model FD generated in step S64 is determined to be the first model FD having the highest identification performance. On the other hand, when the identification performance of the first model FD generated by the replacement is higher than the identification performance of the first model FD before the replacement generated in step S64, step S66 is executed again. That is, the first model FD is generated by training the first model FD by using the important factor data element xj that has the next highest influence. The identification performance of the first model FD generated one step before and the identification performance of the first model FD generated this time are compared. When the identification performance of the first model FD generated one step before is higher than the identification performance of the first model FD generated this time, the first model FD generated one step before is determined to be the first model FD having the highest identification performance. On the other hand, when the identification performance of the first model FD generated one step before is lower than the identification performance of the first model FD generated this time, the process of step S66 is executed again. In this way, En number of factor data elements xi are extracted, that is, are selected from the important factor data elements x1 to x100 by repeatedly executing the process of step S66 until the first model FD having the highest identification performance is determined.

The step S66 may be omitted. For example, in step S63 executed when the number of factor data elements En is “1” and “2”, step S66 may be omitted. This is because it is considered that the first model FD generated using the factor data element xi or the factor data elements x1 and x2 in step S64 has the highest identification performance when the number of factor data elements En is “1” or “2”.

In step S68 after step S63, the processor 35 determines whether the first model FD determined in step S63 satisfies the end condition by using the data element for verification. In the present embodiment, in step S68, it is determined whether the resulting object 200 with which the first state is associated is correctly identified at a predetermined ratio or more using the coefficient of determination.

In the step S68, when it is determined that the end condition is satisfied, the processor 35 executes the training end determination. In the training end determination, the processor 35 determines whether the training of the first model FD or the training of the second model SD by the recursive call described later when the end condition is not satisfied, is executed for all the number of factor data elements En. Specifically, in step S74, the processor 35 adds “1” to the value of the number of factor data elements En determined in step S62. Next, in step S76, the processor 35 determines whether the value of the number of factor data elements En after the addition is less than or equal to the upper limit number n. When the value of the number of factor data elements En after the addition is less than or equal to the upper limit number n, the value of the number of factor data elements En after the addition is determined in step S62, and the processes of the subsequent steps of step S63 are executed. On the other hand, when the value of the number of factor data elements En after the addition exceeds the upper limit number n, the processor 35 performs a factor extraction in step S78.

As a result of the processing up to immediately before step S78, for each of the loops of the loop processes formed by steps S62 to S76, that is, for each of the outermost loops, the factor combination that best identifies the resulting object 200 with which the first state is associated is extracted. These factor combinations are stored in the storage section 31 for each loop (that is, the number of outermost loops). For example, when the number of factor data elements En is “2” when the first model FD is trained, by inputting the factor combination (x2, x4), the first model FD may best identify the resulting object 200 with which the first state is associated. Alternatively, for example, when the number of factor data elements En is “2” when the first model FD is trained, and when the number of factor data elements En is “3” when the second model SD is trained, by inputting the factor combination (x12, x40) to the first model FD and the factor combination (x21, x33, x80) to the second model SD, the output of the first model FD and the output of the second model SD may best identify the resulting object 200 with which the first state is associated. As described above, the storage section 31 stores the factor combination having the highest identification performance for each loop of the loop process formed in steps S62 to S76.

Instep S78, by referencing the factor combination stored in the storage section 31, the model that is trained by the corresponding factor combination (or an identifier for identifying the model), and the performance of the estimation result (regression result, discrimination result) output by the model that is trained by the factor combination, and from among these references, the factor combination that best identifies the resulting object 200 with which the first state is associated, is extracted (selected). The processing content of step S78 is the same as the processing content of step S40 illustrated in FIG. 2.

In step S68, when it is determined that the end condition is not satisfied, the processor 35 executes the continuation process for the recursive call in step S70. Specifically, the processor 35 deletes the factor data elements xi used for the training of the first model FD or the second model SD from the data set for training 39 in the step before step S70. Accordingly, the factor data elements xi used previously as the input element at the time of training of the first model FD or the second model SD are excluded from the target of the input element at the time of training of the second model SD next time. Further, in step S70, the processor 35 calculates a predicted value which is an output element of the first model FD and a “residual difference between the actual measurement value and the predicted value” which is an input element and sets this residual difference as a new target of prediction.

After step S70, the processor 35 executes the recursive call of steps S62 to S70. That is, until the end condition is satisfied, the training of the second model SD is executed using the important factor data elements other than the factor data elements xi used previously for the training of the first model FD or the second model SD. The second model SD which is trained by the Nth recursive call is also referred to as a second model SDN. “N” is an integer of 1 or more.

After step S72, the training end determination in steps S74 and S76 is executed, and when the value of the number of factor data elements En after the addition exceeds the upper limit number n, the processor 35 performs a factor extraction in step S78. In step S78, the processing content is the same as that in step S40 illustrated in FIG. 2, and the processor 35 extracts at least one factor combination that has the highest ratio capable of identifying the first state as a total. That is, the processor 35 extracts at least one factor combination that identifies the resulting object 200 with which the first state is associated at the highest ratio by using the trained first model FD and the trained second model SD as desired.

On the other hand, in step S76, when the value of the number of factor data elements En after the addition is less than or equal to the upper limit number n, the processor 35 determines the value of the number of factor data elements En after the addition as the number of factors of the factor data elements xi after the addition in step S62. The processor 35 regards a third combination having the factor data elements xi of the newly determined number of factors as the first combination, and executes the processes of the subsequent steps of step S63 again. That is, when steps S74 and S76 are executed when the number of factors of the number of factor data elements En is “1”, step S63 is executed with the number of factors is “2” . By doing so, the first model FD or the second model SD can be trained by using the third combination having the factor data elements xi with the number of factors different from the number of factors of the first factor data elements.

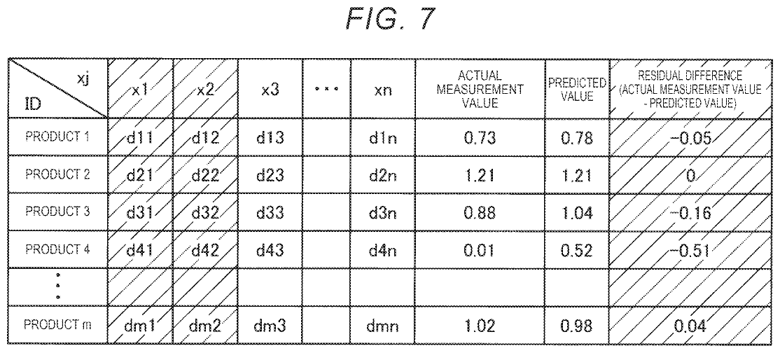

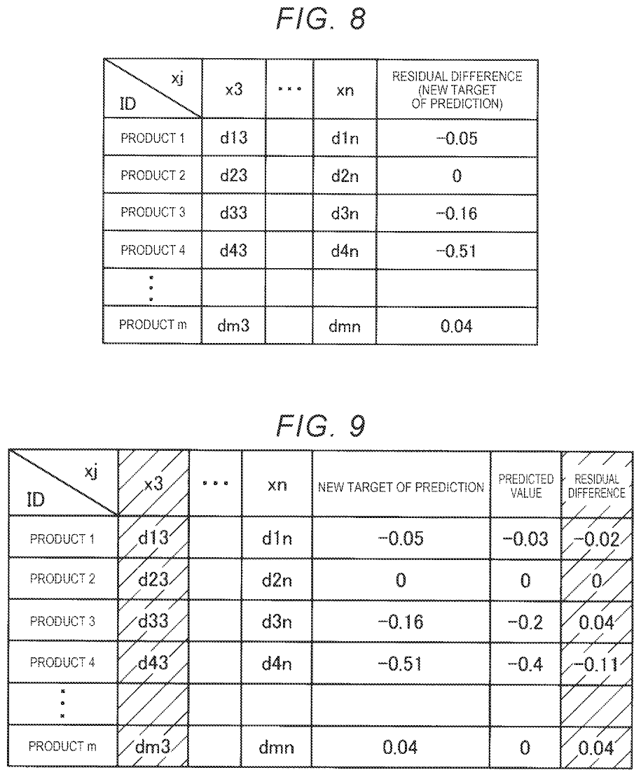

A specific example of the above-described factor search process will be described with reference to FIGS. 6 to 9. FIG. 6 is a first diagram for explaining the factor search process. FIG. 7 is a second diagram for explaining the factor search process. FIG. 8 is a third diagram for explaining the factor search process. FIG. 9 is a fourth diagram for explaining the factor search process. The factor search process is executed by executing a search method.

In FIGS. 6 to 9, the contents of the factor data elements x1 to xn, which are the important factor data elements xj and the actual measurement values, which are the targets of prediction are described correlating with the plurality of the resulting objects 200. The plurality of the resulting objects 200 are products 1 to m. In the present embodiment, “n” in xn is “100”. The contents illustrated in FIGS. 6 to 9 are stored in the data set for training 39. For example, when the number of factor data elements En is “2”, a first model FD2 that is trained using the important factor data elements x1 and x2 has the highest identification performance. In this case, in the continuation process in step S70 illustrated in FIG. 5, the processor 35 deletes the important factor data elements x1 and x2 from the data set for training 39, as illustrated in FIG. 7. Further, in the continuation process, the processor 35 calculates a residual difference between the predicted value that is the output element of the first model FD and the actual measurement value that is the input element, and overwrites the residual difference on the data set for training 39, and then sets this residual difference as a new predicted value. That is, as illustrated in FIG. 8, the processor 35 trains the second model SD so that the residual difference can be output by using the important factor data elements x3 to xn which are not used in the first model FD and the residual difference.

As a result of training of the second model SD using the data set for training 39 in FIG. 8, when the number of factor data elements En is “1”, the first model FD which is trained using the important factor data element x3 has the highest identification performance. In this case, as illustrated in FIG. 9, in the continuation process in step S70 in the first recursive call, the processor 35 deletes the important factor data element x3 from the data set for training 39. Further, in the continuation process, the processor 35 calculates a residual difference between the predicted value that is the output element of the second model SD and the predicted value that is the residual difference which is the input element and overwrites the residual difference on the data set for training 39. That is, the processor 35 trains the next second model SD so that the residual difference can be output by using the important factor data elements x4 to xn, which are not used for the training of the first model FD and the first recursive call, and the residual difference. The processor 35 trains the second model SD by performing the recursive call and generates the second model SD until the end condition is satisfied.

According to the first embodiment described above, by extracting a factor combination using the trained first model FD and the trained second model SD as desired, the factor data elements xi associated with the first state can be efficiently extracted. In particular, according to the first embodiment described above, even when the factors in the first state are classified into a plurality of factors, by extracting a factor combination using the trained first model FD and the trained second model SD as desired, the factor data elements xi associated with the first state can be efficiently extracted.

### B. Second Embodiment

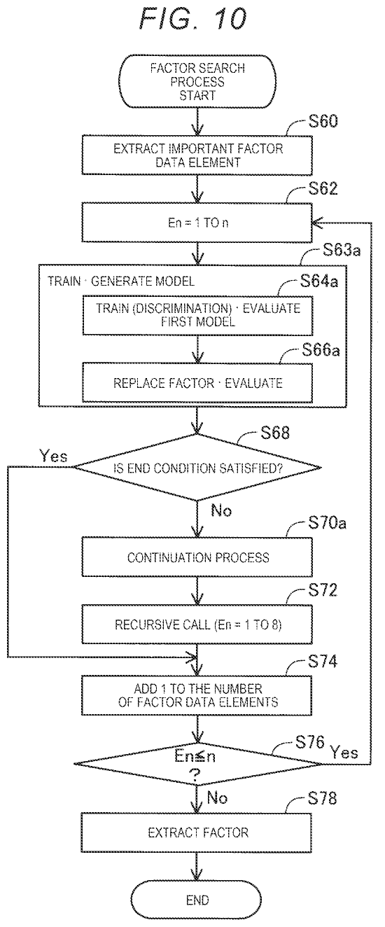

FIG. 10 is a flowchart of a factor search process executed by the processor 35 of the second embodiment. The difference between the first embodiment and the second embodiment is the processing content of steps S63a, S68a, and S70a. An analysis system 100 according to the second embodiment has the same configuration as the analysis system 100 of the first embodiment, and therefore description thereof will be omitted. Further, in the factor search process in the second embodiment, the processing contents other than steps S63a, S68a, and S70a are the same as the contents of the factor search process in the first embodiment, and therefore, the same processing contents are denoted by the same reference numerals, and description thereof will be appropriately omitted.

In step S63a, using the factor data element xi belonging to the first combination and the label of the resulting object 200 corresponding to the factor data element xi as an input element, the processor 35 trains a model so that the resulting object 200 with which the first state is associated can be identified, that is, the identification result that the resulting object 200 is a defective product can be output. In the present embodiment, the processor 35 uses an algorithm such as support vector machine (SVM), random forest, or deep learning as the discriminant analysis. In this case, the label of the input element is a label representing one of the first state and the second state. This label represents either the first state, which is a defective product, or the second state, which is a good product.

In step S63a, the processor 35 trains the first model FD by using the factor data element xi belonging to the first combination and the label of the resulting object 200 as input elements. Further, in step S63a, the processor 35 evaluates the identification performance of the trained first model FD. Specifically, the processor 35 uses the data element for verification as an input element to the first model FD, evaluates the identification performance using area under the curve (AUC), and determines the first model FD having the highest identification performance in the number of factor data elements En determined in step S62. Further, in step S64, the processor 35 may calculate the ratio of the output element of the first model FD in the first state, that is, the explained defective ratio using the resulting objects 200 in the first state. The first model FD having the highest identification performance for each number of factor data elements En is referred to as first models FD1 to FD8. The number at the end is a number corresponding to the number of factor data elements En.

Next, in step S66a, the processor 35 trains the first model FD by replacing the important factor data elements xj of the first combination used for training the first model FD. For example, the first model FD is generated by training the first model FD by replacing the important factor data elements xj in the descending order of influence extracted in step S60. Further, in step S66a, the processor 35 evaluates the identification performance of the first model FD generated by replacing the important factor data elements xj. When the identification performance of the first model FD generated by the replacement is lower than the identification performance of the first model FD before the replacement generated in step S64a, the first model FD generated in step S64a is determined to be the first model FD having the highest identification performance. On the other hand, when the identification performance of the first model FD generated by the replacement is higher than the identification performance of the first model FD before the replacement generated in step S64a, step S66a is executed again. That is, the first model FD is generated by training the first model FD by using the important factor data element xj that has the next highest influence. The identification performance of the first model FD generated one step before and the identification performance of the first model FD generated this time are compared. When the identification performance of the first model FD generated one step before is higher than the identification performance of the first model FD generated this time, the first model FD generated one step before is determined to be the first model FD. On the other hand, when the identification performance of the first model FD generated one step before is lower than the identification performance of the first model FD generated this time, the process of step S66a is executed again. In this way, the process of step S66a is repeatedly executed until the first model FD is determined.

In step S68a, the processor 35 determines whether the model which is determined in step S63a, for example, the first model FD satisfies the end condition by using the data element for verification. In the present embodiment, processor 35 determines whether the resulting object 200 with which the first state is associated is correctly identified at a predetermined ratio or more using the AUC. Specifically, the processor 35 determines that the identification is correctly performed when the AUC is less than a predetermined value. In another embodiment, step S68a may be executed by combining the explained defective ratio and the AUC. For example, the processor 35 may determine that the end condition is satisfied when the AUC is less than the predetermined value or when the explained defective ratio is high.

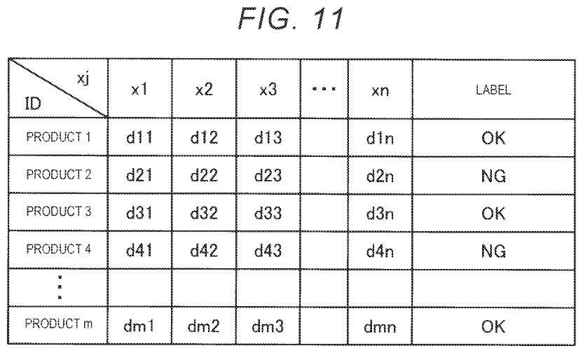

When the first model FD generated in step S63a does not satisfy the end condition, the processor 35 executes the continuation process for the recursive call in step S70a. Specifically, the processor 35 excludes factor data elements xi used for the training of the model from the input element targets of the model by deleting the factor data elements xi from the data set for training 39 in the step before step S70a. Further, regarding the training of the first model FD, the processor 35 deletes the data element for the resulting object 200, in which the labels of the input element and the output element match with the first state, and the data element in the row direction illustrated in FIG. 11 described later from the data set for training 39.

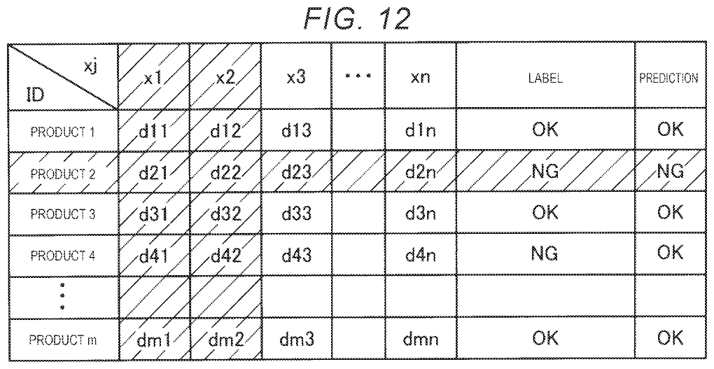

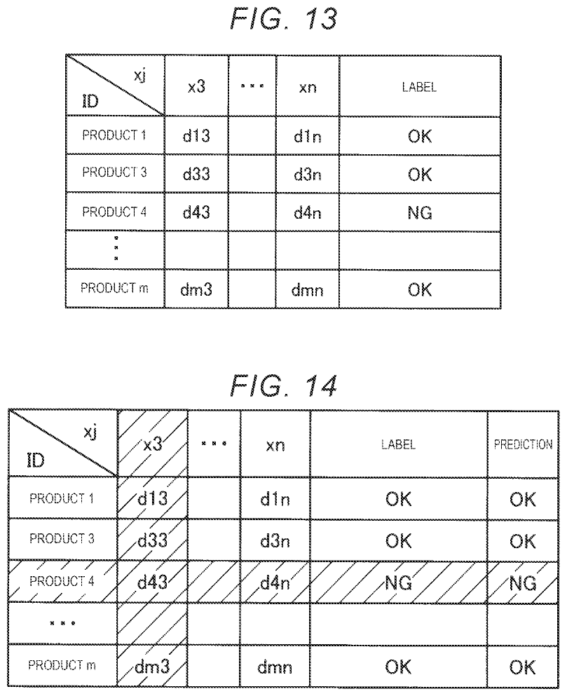

FIG. 11 is a first diagram for explaining the factor search process. FIG. 12 is a second diagram for explaining the factor search process. FIG. 13 is a third diagram for explaining the factor search process. FIG. 14 is a fourth diagram for explaining the factor search process. The plurality of the resulting objects 200 are products 1 to m. In FIGS. 11 to 14, the contents of the factor data elements x1 to xn, which are the important factor data elements xj and the labels, which are the targets of prediction are described correlating with the plurality of the resulting objects 200. In FIGS. 11 to 14, “OK” represents a “good product label” and “NG” represents a “defective product label”. In the present embodiment, “n” in xn is “100”. The contents illustrated in FIGS. 11 to 14 are stored in the data set for training 39.

By the process in step S60 illustrated in FIG. 10, the important factor data elements x1 to xn are extracted. As illustrated in FIG. 11, the data elements corresponding to the extracted important factor data elements x1 to xn, for example, the labels or the contents of the important factor data elements x1 to xn are associated with each other for each resulting object 200 and stored in the data set for training 39.

As illustrated in FIG. 12, when the number of factor data elements En is “2”, the first model FD2 that is trained using the important factor data elements x1 and x2 has the highest identification performance. In this case, in the continuation process in step S70a illustrated in FIG. 10, the processor 35 deletes the important factor data elements x1 and x2 from the data set for training 39, as illustrated in FIG. 11. Further, in the continuation process, the processor 35 deletes the data element for the resulting object 200, in which the content of the label which is the input element and the content of the output element match with the first state, from the data set for training 39. That is, as illustrated in FIG. 13, the processor 35 trains the second model SD so that the label that is an input element can be output by using the important factor data elements x3 to xn which are not used when training the first model FD2 and the label.

As a result of training of the second model SD using the data set for training 39 in FIG. 13, when the number of factor data elements En is “1”, the second model SD which is trained using the important factor data element x3 has the highest identification performance. In this case, in the continuation process of step S70 in the first recursive call, the processor 35 deletes the important factor data element x3 and the data element for the resulting object 200, in which the content of the label which is the input element and the content of the output element match with the first state, from the data set for training 39. The processor 35 trains the second model SD by performing the recursive call and generates the second model SD until the end condition is satisfied.

According to the second embodiment, the same effect can be obtained in that it has the same configuration as that of the first embodiment. For example, by extracting a factor combination using the trained first model FD and the trained second model SD as desired, the factor data elements xi associated with the first state can be efficiently extracted. Further, according to the second embodiment, the processor 35 can train the first model FD or the second model SD using the discriminant analysis algorithm.

### C. Other Embodiments

### C-1. First Other Embodiment

In each of the above-described embodiments, the processor 35 executes the extraction of the important factor data elements xj as illustrated in FIG. 5, but it may be omitted. In this case, the processor 35 executes the factor search process using the basic data set 34 as a data set.

### C-2. Second Other Embodiment

In each of the above-described embodiments, the end condition is a condition that the trained first model FD or the second model SD correctly identifies the resulting object 200 with which the first state indicating a defective product is associated at a predetermined ratio or more, but may further include the following additional condition. The additional condition is a condition that the number of factors of the factor data elements xi of the data set for training 39 is equal to or less than a predetermined value. This is because when the number of factors of the factor data elements xi of the data set for training 39 decreases, there is a possibility that the model cannot be generalized.

### C-3. Third Other Embodiment

In each of the above-described embodiments, the processor 35 may use a cross-verification when evaluating the identification performance of the model. For example, the processor 35 may use the cross-verification when performing steps S64 and S66 illustrated in FIG. 5.

### C-4. Fourth Other Embodiment

In the second embodiment described-above, when the data elements used for the training of the model are biased, for example, when there are few data elements that indicate “a defective product” as a label, the processor 35 may execute preprocessing such as synthetic minority over-sampling technique (SMOTE) before training of the model. As a result, insufficient data elements can be complemented, so that the discrimination accuracy using the trained model can be improved.

### D. Other Forms

The present disclosure is not limited to the above-described embodiments and can be realized with various configurations without departing from the spirit of the present disclosure. For example, the technical features in the embodiments corresponding to the technical features in each form described in the section of the outline of the disclosure can be appropriately replaced or combined in order to solve some or all of the above problems or to achieve some or all of the above effects. Further, when the technical features are not described as essential in this specification, they can be deleted as appropriate.

(1) According to one aspect of the present disclosure, there is provided a search method in which at least one or more processors search for a factor associated with a first state using a data set including (i) a plurality of factor data elements which are linked to each of a plurality of the resulting objects manufactured or processed by a manufacturing process or a processing process and which represent a plurality of factors and (ii) a label which is used for representing one of the first state and the second state and which is associated with the resulting object. The search method includes: (a) using (i) at least one of first factor data elements belonging to a first combination as a factor combination among the plurality of factor data elements and (ii) the label corresponding to the first factor data element, training a first model such that the resulting object with which the first state is associated, can be correctly identified from the at least one of the first factor data elements; (b) determining whether the trained first model correctly identifies the resulting object with which the first state is associated at a predetermined ratio or more using the first factor data element belonging to the first combination; (c) in the step (b), when it is determined that the resulting object cannot be correctly identified at the ratio or more, using (i) a second factor data element which is at least one of second factor data elements belonging to a second combination as the factor combination among the plurality of factor data elements and different from the first factor data element and (ii) the label corresponding to the second factor data element, training a second model such that the resulting object with which the first state is associated, can be correctly identified from the at least one of the second factor data elements; and (d) using the first model trained by the step (a) and the second model trained by the step (c) according to a determination result of the step (b), extracting at least one of the factor combinations that identifies the resulting object with which the first state is associated at a highest ratio. According to this aspect, by extracting a factor combination using the trained first model and the trained second model as desired, the factor data elements associated with the first state can be efficiently extracted.

(2) The search method may further include extracting a plurality of important factor data elements having a high degree of influence on the first state from among the plurality of factor data elements before executing the step (a), and executing a subsequent process of the step (a) using the extracted plurality of important factor data elements. According to this aspect, by extracting the plurality of important factor data elements and using them for training the first model or the second model, it is possible to reduce the amount of data used when training of the first model or the second model.

(3) The search method may further include assuming a third combination having factor data elements with the number of factors different from the number of factors of the first factor data elements belonging to the first combination as the first combination, repeating the step (a) and the step (b), and the step (c) according to a determination of the step (b). According to this aspect, by training the first model or the second model by using the third combination having the factor data elements with the number of factors different from the number of factors of the first factor data elements, the factor data element associated with the first state can be extracted more efficiently.

(4) In the search method, the processor may execute training of the first model and the second model using a regression analysis algorithm, and when the first model is trained using the first combination in the step (a), the label may be an actual measurement value obtained by measuring a physical amount of the resulting object, which is used for determining whether the resulting object is in the first state or the second state. According to this aspect, it is possible to train the first model or the second model using regression analysis.

(5) In the search method, in the step (c), when the first model is trained by the first combination in step (a), the label may include a residual difference between the actual measurement value and a predicted value using the first model. According to this aspect, since the label includes the residual difference, it is possible to train the second model efficiently.

(6) In the search method, the processor may execute training of the first model and the second model using a discriminant analysis algorithm. According to this aspect, the first model or the second model can be trained using the discriminant analysis.

In addition to the above-described embodiments, the present disclosure can be realized in the form of a computer program for executing the search method, a non-transitory recording medium recording the computer program, a device for executing the search method, or the like.

What is claimed is:

1. A search method in which at least one or more processors search for a factor associated with a first state using a data set including (i) a plurality of factor data elements which are linked to each of a plurality of resulting objects manufactured or processed by a manufacturing process or a processing process and which represent a plurality of factors and (ii) a label which is used for representing one of the first state and a second state and which is associated with the resulting object, the search method comprising:
(a) by using (i) at least one first factor data element belonging to a first combination as a factor combination among the plurality of factor data elements and (ii) the label corresponding to the first factor data element, training a first model such that the resulting object with which the first state is associated can be correctly identified from the at least one first factor data element;
(b) determining whether the trained first model correctly identifies the resulting object with which the first state is associated at a predetermined ratio or more by using the first factor data element belonging to the first combination;
(c) when it is determined that the resulting object cannot be correctly identified at the ratio or more in the determining (b), by using (i) at least one second factor data element which belongs to a second combination as the factor combination among the plurality of factor data elements and is different from the first factor data element and (ii) the label corresponding to the second factor data element, training a second model such that the resulting object with which the first state is associated can be correctly identified from the at least one second factor data element; and
(d) by using the first model trained by the training (a) and the second model trained by the training (c) according to a determination result of the determining (b), extracting at least one factor combination that identifies the resulting object with which the first state is associated at a highest ratio.

2. The search method according to claim 1, further comprising:
extracting a plurality of important factor data elements having a high degree of influence on the first state from among the plurality of factor data elements before executing the training (a); and
executing a subsequent process of the training (a) by using the plurality of extracted important factor data elements.

3. The search method according to claim 1, further comprising:
by assuming a third combination having factor data elements with the number of factors different from the number of factors of the first factor data elements belonging to the first combination as the first combination, repeating the training (a) and the determining (b), and the training (c) according to a determination of the determining (b).

4. The search method according to claim 1, wherein
the processor executes training of the first model and the second model by using a regression analysis algorithm, and
when the first model is trained using the first combination in the training (a), the label is an actual measurement value obtained by measuring a physical amount of the resulting object, which is used for determining whether the resulting object is in the first state or the second state.

5. The search method according to claim 4, wherein
when the first model is trained by the first combination in the training (a), the label includes a residual difference between the actual measurement value and a predicted value using the first model in the training (c).

6. The search method according to claim 1, wherein
the processor executes training of the first model and the second model by using a discriminant analysis algorithm.

7. A non-transitory computer-readable storage medium storing instructions for executing a method in which at least one or more processors search for a factor associated with a first state using a data set including (i) a plurality of factor data elements which are linked to each of a plurality of resulting objects manufactured or processed by a manufacturing process or a processing process and which represent a plurality of factors and (ii) a label which is used for representing one of the first state and a second state and which is associated with the resulting object,
the method comprising:
(a) by using (i) at least one first factor data element belonging to a first combination as a factor combination among the plurality of factor data elements and (ii) the label corresponding to the first factor data element, training a first model such that the resulting object with which the first state is associated can be correctly identified from the at least one first factor data element;
(b) determining whether the trained first model correctly identifies the resulting object with which the first state is associated at a predetermined ratio or more by using the first factor data element belonging to the first combination;
(c) in the function (b), when it is determined that the resulting object cannot be correctly identified at the ratio or more, by using (i) at least one second factor data element which belongs to a second combination as the factor combination among the plurality of factor data elements and is different from the first factor data element and (ii) the label corresponding to the second factor data element, training a second model such that the resulting object with which the first state is associated can be correctly identified from the at least one second factor data element; and
(d) by using the first model trained by the function (a) and the second model trained by the function (c) according to a determination result of the function (b), extracting at least one factor combination that identifies the resulting object with which the first state is associated at a highest ratio.
